(19) United States
(12) Patent Application Publication
(10) Pub. No.: US 2006/0119905 A1
(43) Pub. Date: Jun. 8, 2006

(54) Optimized scanning speed self adaptive scanner

(75) Inventor: Ching-Chung Chang, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Lite-On Technology Corporation

(21) Appl. No.: 11/292,632

(22) Filed: Dec. 2, 2005

(30) Foreign Application Priority Data
Dec. 7, 2004 (TW) 93137782

(51) Int. Cl. H04N 1/04

(52) U.S. Cl. 358/486

(57) ABSTRACT

A scanner self-adaptive to an optimized scanning speed, comprising: a register storing a scanning speed parameter; a frequency adjusting circuit outputting a driving signal having variable frequency corresponding to the scanning speed parameter using a predetermined method; and a stepping motor controlling the scanning speed of the scanner, coupled to receive the driving signal and changing its rotate speed, as well as the scanning speed of the scanner, corresponding to the frequency of the driving signal.

### BACKGROUND

The invention is related to a scanner, and more particularly, to a scanner with optimized self-adaptive scanning speed.

Stepping motors are typically used in scanners to drive scanning heads.

Carriage jams are a kind of problem typically occurring in scanners. A carriage jam occurs when stepping motor stops rotating due to the environment working against the torque generated by the stepping motor, when the stepping motor receives an active driving signal. To prevent carriage jam, some considerations must be taken into account when designing the scanners.

First, the effective life of a typical scanner is about 8 years and 100,000 scans. To ensure that all scanners can reach the requirement, stepping motor speed is typically hold to 70% of the maximum specification. Second, the voltage level tolerance of the power adapter the scanner connected thereto is typically held to about ±5%. The load a stepping motor carriage can bear has about ±5% tolerance. To meet the tolerance mentioned above, the stepping motor speed is held to 90%. Third, for the scanner to function at 5˜45° C., the speed of stepping motors is further reduced by 5% off for the worst case scenario. Fourth; the speed specification of the stepping motor should be reduced another ±5%, to ensure the scanner operation at various angles, even vertical. To ensure the designed scanning speed is applicable to scanners of the same model, the speed specification of the stepping motor should be reduced by about 50%.

Additionally, the scanning quality of the scanner is proportional to the number of illuminations per scanning cycle. The scanning duration can be reduced using a higher scanning speed, while the scanning quality can be better using a lower scanning speed. If the scanner can scan at only one speed, scanning speed cannot be altered to fulfill individual requirements.

FIG. 1 is a block diagram of a conventional scanner 10. A frequency divider 12 receives an oscillating signal F_{c} with a static frequency generated by an oscillator 11, and outputs a driving signal Dₘ by dividing the frequency of the oscillating signal F_{c} to a stepping motor 13.

The frequency divider 12 uses a static ratio to divide the oscillating signal F_{c}. As soon as the specification of the oscillator 11 is determined, the speed of the stepping motor is set and the scanning speed of the scanner is then fixed. There is no easy way to adjust the scanning speed to adapt to the current condition of the scanner. Scanners with the same specifications must shares the same scanning speed, which is determined to operate under the worst case scenario of all required operational specification.

### SUMMARY

The present invention relates to a drive circuit for a scanner that obviates one or more of the problems due to limitations and disadvantages of the related art.

Consistent with the present invention, there is provided a scanner self-adaptive to an optimized scanning speed, comprising: a register storing a scanning speed parameter; a frequency adjusting circuit outputting a driving signal having variable frequency corresponding to the scanning speed parameter using a predetermined method; and a stepping motor controlling the scanning speed of the scanner, coupled to receive the driving signal and change the rotational speed thereof, as well as the scanning speed of the scanner, corresponding to the frequency of the driving signal.

Consistent with the present invention, there is provided a scanner self-adaptive to an optimized scanning speed, further comprising a carriage jam detector which deducts the scanning speed parameter value stored in the register, when a carriage jam of the scanner is detected by the carriage jam detector.

Additional features and advantages of the invention will be set forth in part in the description which follows, and in part will be obvious from the description, or may be learned by practice of the invention. The features and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### DESCRIPTION OF THE DRAWINGS

The accompanying drawings, which are incorporated in and constitute a part of this specification, illustrate several embodiments of the invention and together with the description, serve to explain the principles of the invention.

FIG. 1 is a block diagram of a conventional scanner 10.

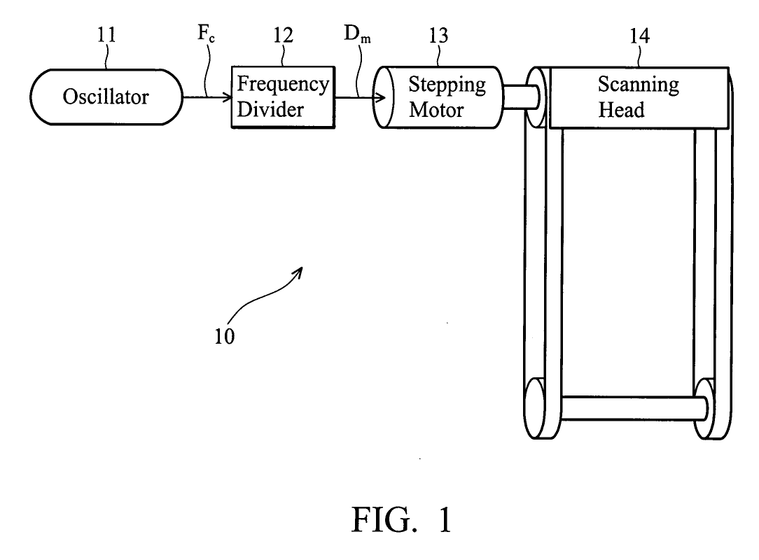

FIG. 2 is a block diagram of a scanner 20 consistent with the first embodiment of the invention.

FIG. 3 is a block diagram of a scanner 30 consistent with the second embodiment of the invention.

FIG. 4 is a block diagram of a scanner 40 consistent with the third embodiment of the invention.

### DETAILED DESCRIPTION

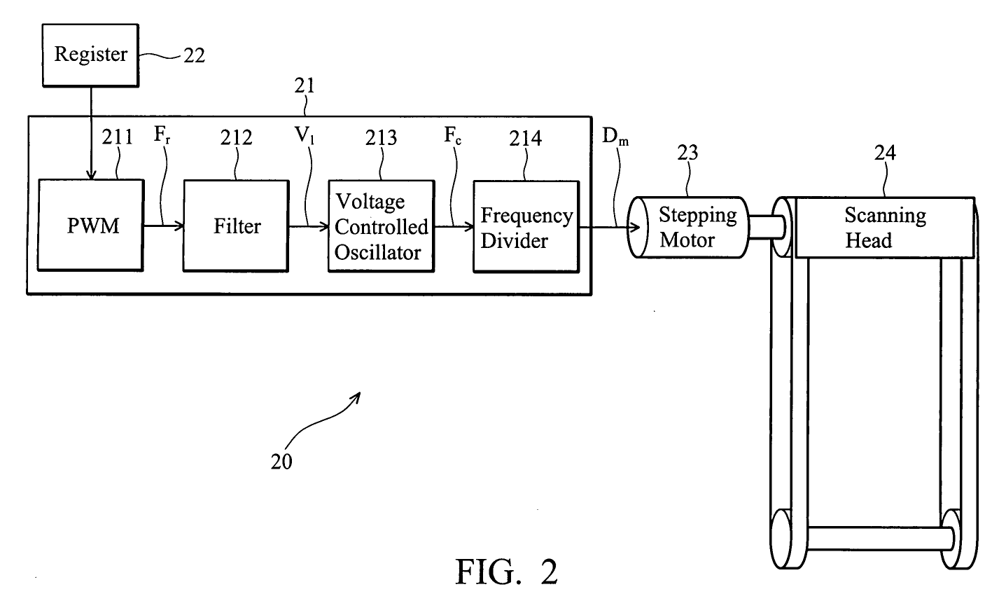

FIG. 2 is a block diagram of a scanner 20 consistent with the first embodiment of the invention. The scanner 20 includes a register 22 storing a scanning speed parameter. A frequency adjusting circuit 21 outputs a driving signal Dₘ with programmable frequency corresponding to the scanning speed parameter. A stepping motor 23 controlling the scanning speed of the scanner 20 is coupled to receive the driving signal Dₘ. The rotational speed of the stepping motor 23 corresponds to the frequency of the driving signal Dₘ, and therefore changes the scanning speed of the scanner 20.

FIG. 2 also shows an example of an implementation of the frequency adjusting circuit 21. The frequency adjusting circuit 21 comprises a pulse width modulation (PWM) device 211, a filter 212, a voltage controlled oscillator and a voltage divider 214.

The PWM device 211 outputs a voltage adjusting signal Fᵣ. The voltage adjusting signal Fᵣ is a square waveform whose duty cycle corresponds to the scanning speed parameter stored in the register 22.

The filter 212 is coupled to receive the voltage adjusting signal Fᵣ. The filter 212 filters the voltage adjusting signal Fᵣ and outputs a DC power V₁ whose voltage corresponds to the duty cycle of the voltage adjusting signal Fᵣ. The filter 212 can be a simple resistor-capacitor (RC) filter or other filter. The DC power V₁ has a higher level when the duty cycle has a higher value. The PWM device 211 working with the filter 212 is a typical implementation of a DC-DC power converter, sometimes named a switching power regulator. The DC power output level corresponds to the scanning speed parameter stored in the register 22.

A voltage controlled oscillator 213 is coupled to receive the DC power V₁ and outputs an oscillating signal F_{c}, whose frequency corresponds to the voltage of the DC power V₁ as determined by the voltage controlled oscillator 213.

A frequency divider 214 coupled to receive the oscillating signal F_{c} outputs the driving signal Dₘ to the stepping motor 23 by dividing the frequency of the oscillating signal F_{c} in a predetermined ratio. The frequency of the driving signal Dₘ is thus adjusted by the changed scanning speed parameter stored in the register 22.

In this embodiment of the invention, the scanning speed of the scanner 20 can be changed by modifying the scanning speed parameter stored in the register 22.

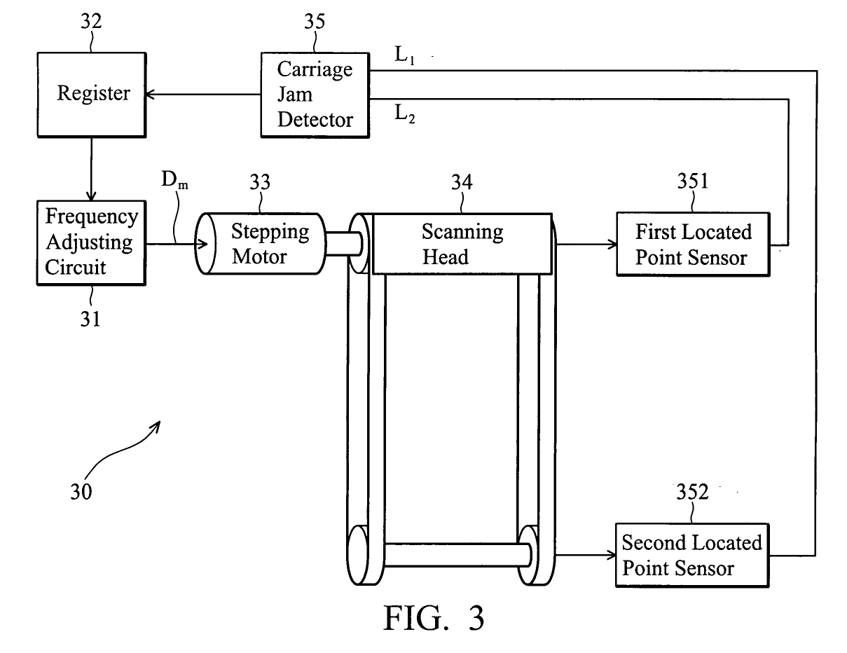

FIG. 3 is a block diagram of a scanner 30 consistent with the second embodiment of the invention. The scanner 30 includes a register 32 storing a scanning speed parameter. A frequency adjusting circuit 31 outputs a driving signal Dₘ with programmable frequency corresponding to the scanning speed parameter. A stepping motor 23 controlling the scanning speed of the scanner 30 is coupled to receive the driving signal Dₘ. The rotational speed of the stepping motor 33 is corresponding to the frequency of the driving signal Dₘ, and therefore changes the scanning speed of the scanner 30.

The scanner 30 further comprises a carriage jam detector 35. The carriage jam detector 35 deducts the scanning speed parameter value stored in the register 32, when a carriage jam of the scanner is detected by the carriage jam detector 35.

The carriage jam detector 35 connects to a first located point sensor 351 and a second located point sensor 352. The first located point sensor 351 generates a signal L₂ to inform the carriage jam detector 35 that the scanning head 34 is arriving or leaving a first located point. The second located point sensor 352 generates a signal L₁ to inform the carriage jam detector 35 the scanning head 34 is arriving or leaving a second located point. The carriage jam detector 35 can then determine the scanning speed, as a first time length, by calculating the time required for the scanning head 34 to travel from the first located point to the second located point, or the time required for the scanning head 34 to travel from the second located point to the first located point. The carriage jam detector 35 then compares the first time length with a reference time length corresponding to the current scanning speed for determining if any carriage jams have occurred. The reference time length is the time required for the scanning head 34 to travel from the first located point to the second located point or from the second located point to the first located point using the same scanning speed. The reference time length can be found by providing a reference scanner which can run without carriage jam in a reference environment, with scanning speed thereof set to any value at which the current model might run. By calculating the time required for the scanning head 34 of a reference scanner to travel from the first located point to the second located point or from the second located point to the first located point at the varied speeds, a table storing reference time lengths at different scanning speeds is recorded in the system controlling the scanner. The carriage jam detector 35 can then access the reference time length according to the current scanning speed from the system.

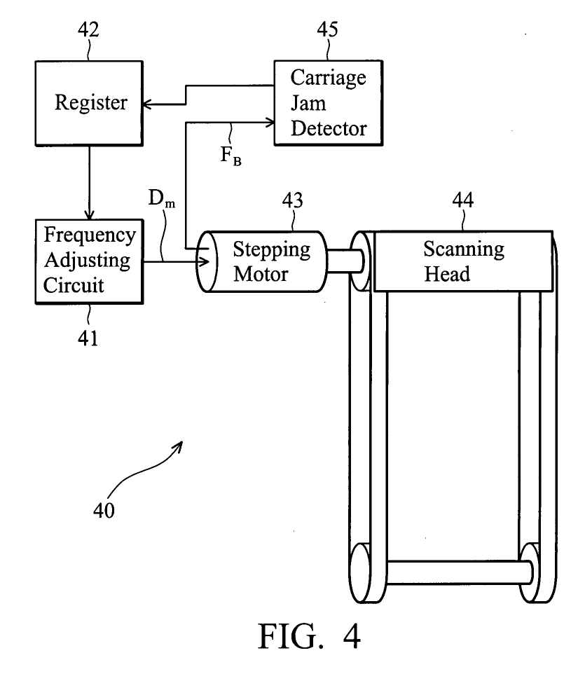

FIG. 4 is a block diagram of a scanner 40 consistent with the third embodiment of the invention. The scanner 40 includes a register 42 storing a scanning speed parameter. A frequency adjusting circuit 41 outputs a driving signal Dₘ with programmable frequency corresponding to the scanning speed parameter. A stepping motor 43 controlling the scanning speed of the scanner 40 is coupled to receive the driving signal Dₘ. The rotational speed of the stepping motor 43 corresponds to the frequency of the driving signal Dₘ, and therefore changes the scanning speed of the scanner 40.

The scanner 40 further comprises a carriage jam detector 45. The carriage jam detector 45 deducts the scanning speed parameter value stored in the register 42, when a carriage jam of the scanner is detected by the carriage jam detector 45.

The carriage jam detector 45 connects to an induced output terminal F_{B} of the stepping motor 43. When the stepping motor 43 receives an active driving signal Dₘ, the magnet inside the stepping motor changes its position and therefore the magnetic flux field inside the stepping motor is changed. The coil of the induced output terminal F_{B} induces the magnetic flux change and generates a first waveform. A waveform comparator inside the carriage jam detector 45 compares the first waveform with a reference waveform to determine if a carriage jam has occurred. The reference waveform is the waveform output from an induced output terminal of the stepping motor 43 without carriage jams, which can be measured from a reference scanner working in a reference environment.

By using the embodiments consistent with the invention, there is no need to determine a specified scanning speed for the same scanner models. Users can program a scanner to work at the scanning speed they prefer regardless of the condition and the environment the scanner is used. Users can also program the scanner to scan at lower speeds if they wish to achieve better scanning quality. Therefore, the scanners can adapt to an optimized scanning speed, thus fulfilling the personal or environmental requirements.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A scanner self-adaptive to an optimized scanning speed, comprising:
a register storing a scanning speed parameter;
a frequency adjusting circuit outputting a driving signal having variable frequency corresponding to the scanning speed parameter using a predetermined method; and
a stepping motor controlling the scanning speed of the scanner, coupled to receive the driving signal and changing its rotational speed, as well as the scanning speed of the scanner, corresponding to the frequency of the driving signal.

2. A scanner self-adaptive to an optimized scanning speed as claim 1, wherein the frequency adjusting circuit comprises:
a pulse width modulation (PWM) device outputting a voltage adjusting signal whose duty cycle corresponds to the scanning speed parameter stored in the register;
a filter coupled to receive the voltage adjusting signal and output a DC power whose voltage corresponds to the duty cycle of the voltage adjusting signal;
a voltage controlled oscillator coupled to receive the DC power and output an oscillating signal, whose frequency corresponds to the voltage of the DC power; and
a frequency divider coupled to receive the oscillating signal and then output the driving signal by dividing the frequency of the oscillating signal.

3. A scanner self-adaptive to an optimized scanning speed as claim 1, further comprising a carriage jam detector which deducts the scanning speed parameter value stored in the register, when a carriage jam of the scanner is detected by the carriage jam detector.

4. A scanner self-adaptive to an optimized scanning speed as claim 3, wherein the carriage jam detector comprises a scanning time detector measuring a first time length a scanning head used to travel from a first located point to a second located point, then compares the first time length with a reference time length corresponding to the current scanning speed for determining if any carriage jam has occurred.

5. A scanner self-adaptive to an optimized scanning speed as claim 4, wherein the reference time length is the time length a scanning head used to travel from the first located point to the second located point using the same scanning speed without any carriage jams.

6. A scanner self-adaptive to an optimized scanning speed as claim 3, wherein the carriage jam detector comprises a waveform comparator comparing a first waveform output from an induced output terminal of the stepping motor with a reference waveform for determining if any carriage jams have occurred.

7. A scanner self-adaptive to an optimized scanning speed as claim 6, wherein the reference waveform is the waveform output from an induced output terminal of the stepping motor without carriage jams.
